(19) United States
(12) Patent Application Publication
(10) Pub. No.: US 2009/0003719 A1
(43) Pub. Date: Jan. 1, 2009

(54) ENCODING DEVICE

(75) Inventor: Masahiro KOANA, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/146,720

(22) Filed: Jun. 26, 2008

(30) Foreign Application Priority Data
Jun. 27, 2007 (JP) 2007-169259

(51) Int. Cl. G06K 9/36

(52) U.S. Cl. 382/239

(57) ABSTRACT

An encoding device includes an image processing unit that performs image processing on image data, using an image processing parameter, a throughput measuring unit that measures throughput necessary in the image processing performed by the image processing unit, a parameter configuring unit that configures the image processing parameter to the image processing unit, based on a magnitude relation between the throughput measured by the throughput measuring unit and a budget, and an encoder that encodes the image data processed by the image processing unit, and generates encoded data.

### CROSS-REFERENCE TO RELATED APPLICATION

This application is based upon and claims the benefit of priority from the prior Japanese Patent Application No. 2007-169259, filed on Jun. 27, 2007; the entire contents of which are incorporated herein by reference.

### BACKGROUND OF THE INVENTION

1. Field of the Invention

The present invention relates to an encoding device, and more particularly, to an encoding device that sets an image processing parameter based on a throughput in an encoding process and a variation of Q factor.

2. Related Art

In recent years, high-performance, highly-sophisticated image compressing techniques such as MPEG4 and H.264 have been standardized, and are now being used in various portable devices such as portable video game machines and cellular phone devices. It is difficult to mount the highly-sophisticated system on those portable devices, as there are limits to the size and the amount of power consumption. However, there is still a demand for high-performance encoding devices that can provide higher image quality and resolution.

In an encoding device, there are some items that need standard processing. However, the standard profiles and levels are modified to meet the device specification, so that image sizes and tools to be used can be arbitrarily selected. In the case of H.264, for example, there is the restriction that values determined according to the standards are subjected to 2-tap filtering after 6-tap filtering is performed on a reference image when movement in each ¼ pel pixel unit is predicted. Also, parameters that can be arbitrarily set include methods and ranges for movement searches, and criteria for determining Intra/Inter predictions.

Therefore, an encoding device is designed after the on/off timings of various tools and parameters are adjusted so that the highest possible image quality can be achieved without a missing frame, and the amount of codes becomes as close as possible to the set value. Missing frames are observed in a case where the process time increases for some reason, and the frames to be encoded cannot be properly encoded.

Therefore, for a prepared video resource (standardized images), each process is set to be completed within the budget allocated to one frame (or one macro block) calculated from the capacity, the image size, or the frame rate.

For example, the image encoding device disclosed in Japanese Laid-Open Patent Application Publication No. 2006-121538 discloses a unit that selects one of several encoding modes and modifies the conditions for the quantizing parameter that varies within a predetermined range, and measures the encoding error and the amount of codes determined from the decoded image and original image of each macro block.

However, the image encoding device disclosed in Japanese Laid-Open Patent Application Publication No. 2006-121538 does not disclose a unit that measures the throughput necessary in each encoding process. Therefore, there is no guarantee that the throughput falls within the budget, if a nonstandard image is input to the device.

To sum up, when a nonstandard image is input to a conventional encoding device, there might be a missing frame in decoded images. Moreover, when a nonstandard image is input to a conventional encoding device, the amount of codes might increase through each encoding process.

### SUMMARY OF THE INVENTION

According to a first aspect of the present invention, there is provided that an encoding device comprising:

an image processing unit that performs image processing on image data, using an image processing parameter;

a throughput measuring unit that measures throughput necessary in the image processing performed by the image processing unit;

a parameter configuring unit that configures the image processing parameter to the image processing unit, based on a magnitude relation between the throughput measured by the throughput measuring unit and a budget; and

an encoder that encodes the image data processed by the image processing unit, and generates encoded data.

### BRIEF DESCRIPTION OF THE DRAWINGS

FIG. 1 is a block diagram illustrating the structure of an encoding device 100 in accordance with an embodiment of the present invention.

FIG. 2 is a block diagram showing the functions of the controller 104 of the embodiment of the present invention.

FIG. 3 is a block diagram illustrating the operation of the controller 104 in accordance with the first embodiment of the present invention.

FIG. 4 is a flowchart showing the operation procedures to be carried out in a parameter setting process in accordance with the first embodiment of the present invention.

FIG. 5 schematically shows the parameter configuration table 1064 in accordance with the first embodiment of the present invention.

FIG. 6 is a flowchart showing the operation procedures in a parameter setting process in accordance with the second embodiment of the present invention.

FIG. 7 schematically shows the parameter configuration table 1064 in accordance with the second embodiment of the present invention.

FIG. 8 is a block diagram showing the functions of the controller 104 of the third embodiment of the present invention.

FIG. 9 is a block diagram showing the functions of the controller 104 of the fourth embodiment of the present invention.

FIG. 10 is a flowchart showing the operation procedures to be carried out in a parameter setting process in accordance with the fourth embodiment of the present invention.

FIG. 11 schematically shows the parameter configuration table 1064 of the fourth embodiment of the present invention.

### DETAILED DESCRIPTION OF THE INVENTION

The following is a description of embodiments of the present invention, with reference to the accompanying drawings. It should be noted that the embodiments described below are merely examples, and the scope of the present invention is not limited by those embodiments.

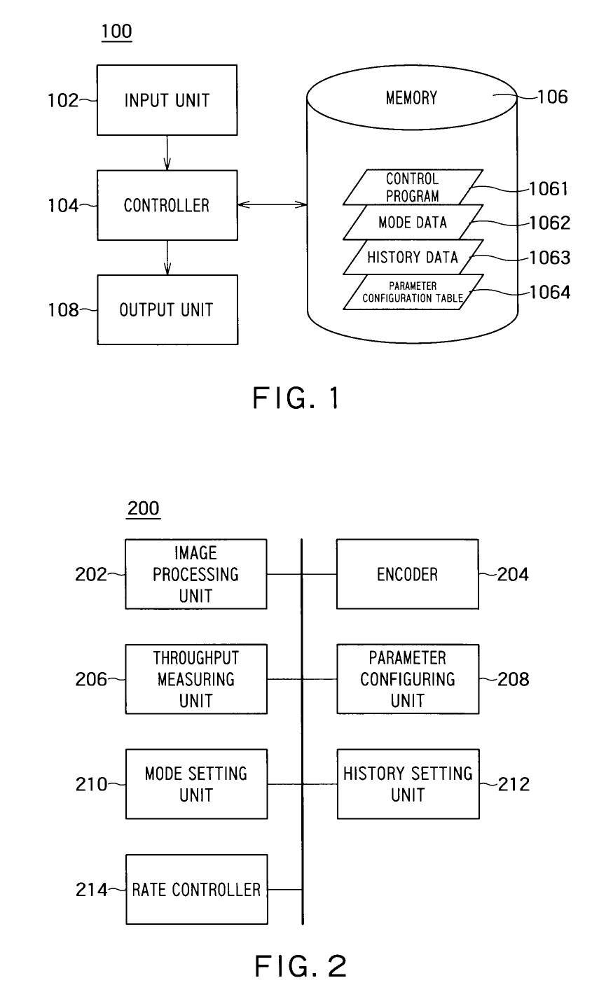

FIG. 1 is a block diagram illustrating the structure of an encoding device 100 in accordance with an embodiment of the present invention. The encoding device 100 in accordance with the embodiment of the present invention includes an input unit 102, a controller 104, a memory 106, and an output unit 108.

The input unit 102 receives image data (such as picture data) to be subjected to encoding.

The controller 104 writes the image data input to the input unit 102 into the memory 106. The controller 104 activates a control program 1061 stored in the memory 106 to function as the later described units 202 to 214. The controller 104 also writes the later described mode data 1062, history data 1063, and parameter configuration table 1064 into the memory 106.

The output unit 108 outputs the later described encoded data (a bit stream) to a predetermined output destination.

FIG. 2 is a block diagram showing the functions of the controller 104 of the embodiment of the present invention. The functions shown in FIG. 2 are realized when the control program 1061 stored in the memory 106 is activated by the controller 104.

The controller 104 of the embodiment of the present invention realizes an image processing unit 202, an encoder 204, a throughput measuring unit 206, a parameter configuring unit 208, a mode setting unit 210, a history setting unit 212, and a rate controller 214.

The image processing unit 202 performs the later described image processing on image data (picture data), using a predetermined image processing parameter, and generates quantized data. The image processing is an image compressing process for H.264 or MPEG4, for example.

The encoder 204 encodes the quantized data generated by the image processing unit 202, using a predetermined encoding parameter, and generates encoded data (a bit stream). The encoder 204 supplies the amount of codes in the encoded data (a bit stream) to the rate controller 214.

The throughput measuring unit 206 measures the throughput necessary for the controller 104 to realize the image processing unit 202 and the encoder 204. For example, the throughput is represented by the number of times of clock or timer interrupts of the controller 104.

The throughput measuring unit 206 may measure the throughput at the same time as the image processing unit 202 and the encoder 204 performing operations, or may measure the throughput by calculating the difference between the start time and the end time of each of the operations performed by the image processing unit 202 and the encoder 204. For example, the throughput measuring unit 206 measures the throughput of each macro block, and calculates the sum of the throughputs to determine the throughput of all the frames of the image data.

The parameter configuring unit 208 configures an image processing parameter to the image processing unit 202, and configures an encoding parameter to the encoder 204.

The mode setting unit 210 refers to the mode data 1062 stored in the memory 106, and sets a mode to the parameter configuring unit 208.

The history setting unit 212 refers to the history data 1063 stored in the memory 106, and sets a history threshold value to the parameter configuring unit 208.

The rate controller 214 calculates the variation of the quantization characteristics (hereinafter referred to as the “Q factor”) for the encoded data (a bit stream) of the next macro block based on the amount of codes in the encoded data (a bit stream) generated by the encoder 204, and outputs the variation to the parameter configuring unit 208.

### First Embodiment

A first embodiment of the present invention is described.

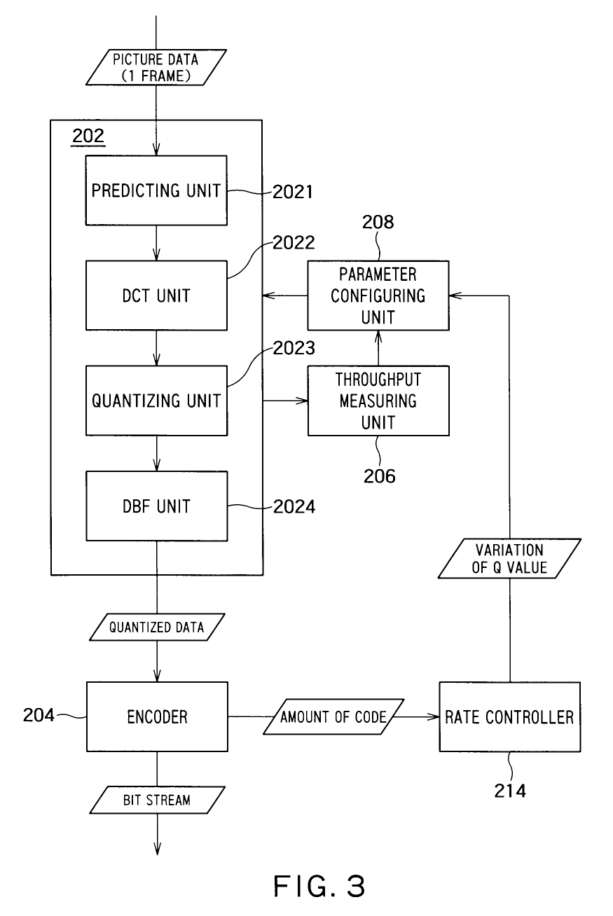

FIG. 3 is a block diagram illustrating the operation of the controller 104 in accordance with the first embodiment of the present invention. The functions shown in FIG. 3 are realized when the control program 1061 stored in the memory 106 is activated by the controller 104.

The controller 104 of the first embodiment of the present invention realizes the above mentioned image processing unit 202, the encoder 204, the throughput measuring unit 206, and the parameter configuring unit 208. The encoder 202 further realizes a predicting unit 2021, a DCT unit 2022, a quantizing unit 2023, and a DBF unit 2024.

The predicting unit 2021 performs a predicted image creating operation such as a motion compensating inter-frame prediction or in-frame prediction in the forward direction or bi-directionally, about the image data (picture data) to be subjected to image processing.

The DCT unit 2022 carries out a discrete cosign transform on the process result of the predicting unit 2021, and generates a DCT coefficient.

The quantizing unit 2023 quantizes the DCT coefficient generated by the DCT unit 2022, using a predetermined quantization matrix, and generates the quantized data.

The DBF unit 2024 performs a deblocking filtering (DBF) operation to eliminate block deformation, if necessary, when the quantizing unit 2023 generates the quantized data.

The encoder 204 encodes the quantized data, and generates the encoded data (a bit stream). The encoder 204 outputs the amount of codes in the encoded data (a bit stream) to the rate controller 214.

The throughput measuring unit 206 measures the throughput for the controller 104 to perform an operation for each of the units 2021 to 2024 of the image processing unit 202, and outputs the measurement result to the parameter configuring unit 208.

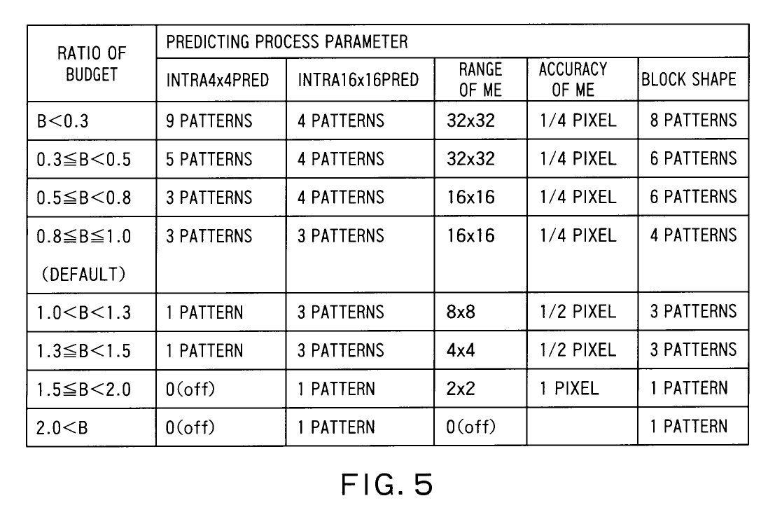

The parameter configuring unit 208 refers to the measurement result that is output from the throughput measuring unit 206, and configures the image processing parameter necessary in the operation of the image processing unit 202, using the parameter configuration table 1064 shown in FIG. 5.

The rate controller 214 calculates the variation of the Q factor, based on the amount of codes that is output from the encoder 204, and outputs the variation to the parameter configuring unit 208.

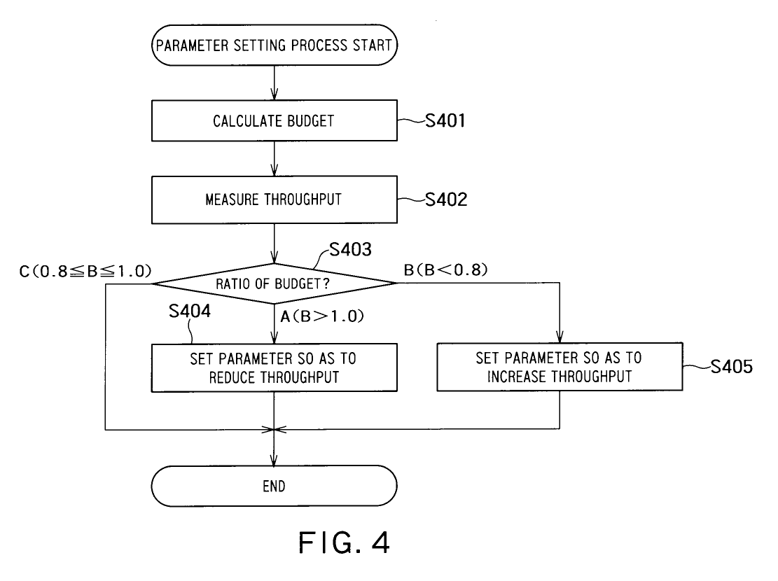

FIG. 4 is a flowchart showing the operation procedures to be carried out in a parameter setting process in accordance with the first embodiment of the present invention. This parameter setting process is carried out for each macro block of image data (picture data).

First, the controller 104 calculates a budget, based on information such as an image size or a frame rate (S401). Alternatively, the controller 104 may carry out the procedures of calculating a budget at the start of an encoding operation, storing the budget into the memory 106, and reads the budget from the memory 106 in step S401. If the budget is calculated at the start of the encoding operation, the controller 104 does not need to calculate the budget for each macro block. For example, the controller 104 calculates the budget of all the frames of the image data, and calculates the average of the budget of each image size or frame rate as the budget of each macro block. A budget is the clock count necessary to process one frame. In the first embodiment of the present invention, a budget is not limited to the clock count necessary to process one frame, but may be any clock count necessary to encode a predetermined process unit such as a frame unit, a slice unit, or a macro block unit.

The throughput measuring unit 206 then measures the throughput necessary for the controller 104 to perform image processing, at the same time as the image processing (S402).

If the budget ratio of the measurement result of step S402 to the budget calculated in step S401 is higher than 1.0 (S403—A), the parameter configuring unit 208 uses the parameter configuration table 1064 shown in FIG. 5, and sets an image processing parameter so as to reduce the throughput necessary for the controller 104 to perform image processing (S404). The parameter setting process in accordance with the first embodiment of the present invention then comes to an end.

If the budget ratio of the measurement result of step S402 to the budget calculated in step S401 is lower than 0.8 (S403—B), the parameter configuring unit 208 uses the parameter configuration table 1064 shown in FIG. 5, and sets an image processing parameter so as to increase the throughput necessary for the controller 104 to perform image processing (S405). The parameter setting process in accordance with the first embodiment of the present invention then comes to an end.

If the budget ratio of the measurement result of step S402 to the budget calculated in step S401 is in the range of 0.8 to 1.0 (S403—C), the parameter setting process in accordance with the first embodiment of the present invention is not carried out and comes to an end. In this case, the image processing unit 202 performs image processing, using the later described default image processing parameter.

In step S403, the parameter configuring unit 208 uses the budget ratio of the measurement result of step S402 to the average budget. For example, in the case of configuring the parameter for the eighth macro block, the parameter configuring unit 208 calculates “the throughput for the first to seventh macro blocks/the total of the average budget for the first to seventh macro blocks”, and uses the value as the budget ratio.

FIG. 5 schematically shows the parameter configuration table 1064 in accordance with the first embodiment of the present invention. The predicting process parameter to be used in the case where the budget ratio measured by the throughput measuring unit 206 is in the range of 0.8 to 1.0 (0.8≦B≦1.0) is the default parameter to be used in the predicting process for the first macro block.

In the case where the budget ratio is lower than 0.8 (B<0.8), the parameter configuring unit 208 sets a predicting process parameter so as to increase the throughput of the predicting unit 2021, for example, to increase the predicting patterns. Here, the predicting process parameter is designed to make the throughput of the predicting unit 2021 larger as the value of the budget ratio is smaller.

In the case where the budget ratio is higher than 1.0, the parameter configuring unit 208 sets a predicting process parameter so as to reduce the throughput of the predicting unit 2021, for example, to reduce the predicting patterns. Here, the predicting process parameter is designed to make the throughput of the predicting unit 2021 smaller as the value of the budget ratio is larger.

Alternatively, the controller 104 of the first embodiment of the present invention may be designed to select each object (one of the image processing units 2021 to 2024) to be subjected to the parameter setting process, in predetermined priority order. For example, in a case where the largest throughput variation is observed when the quantizing unit 2023 is subjected to the parameter setting process, the controller 104 of the first embodiment of the present invention is designed to give the highest priority to the quantizing unit 2023.

Alternatively, the controller 104 of the first embodiment of the present invention may be designed to carry out the parameter setting process for each frame, each macro block, each process stage, or at predetermined intervals, to efficiently control the amount of codes while maintaining high image quality.

Alternatively, the throughput measuring unit 206 of the first embodiment of the present invention may be designed to measure the total throughput of the image processing unit 202 and the encoder 204. The parameter configuring unit 208 of the first embodiment of the present invention may be designed to set parameters for the entire image processing unit 202 and encoder 204, in accordance with the magnitude relation between the throughput of the image processing unit 202 and the encoder 204 and the budget.

Alternatively, the parameter configuring unit 208 of the first embodiment of the present invention may also be designed to set an image processing parameter for the quantizing unit 2023 and the DBF unit 2024.

According to the first embodiment of the present invention, the parameter configuring unit 208 sets an image processing parameter in accordance with the magnitude relation between the throughput and the budget. Thus, even if a nonstandard image is input, it is possible to prevent missing frames.

### Second Embodiment

Next, a second embodiment of the present invention is described. In the first embodiment of the present invention, an image processing parameter is configured in accordance with the magnitude relation between the throughput and the budget. On the other hand, in the second embodiment of the present invention, an image processing parameter is configured in accordance with a variation in the amount of codes, as well as the magnitude relation between the throughput and the budget. Explanation of the same aspects as those in the first embodiment of the present invention is omitted here.

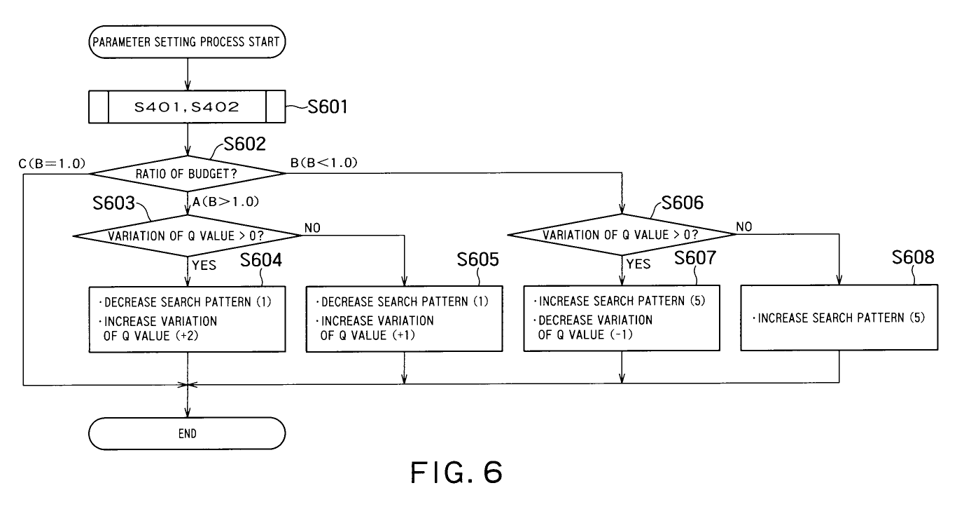

FIG. 6 is a flowchart showing the operation procedures in a parameter setting process in accordance with the second embodiment of the present invention. This parameter setting process is carried out for each macro block of image data (picture data).

First, the same procedures as those of steps S401 and S402 of FIG. 4 are carried out (S601).

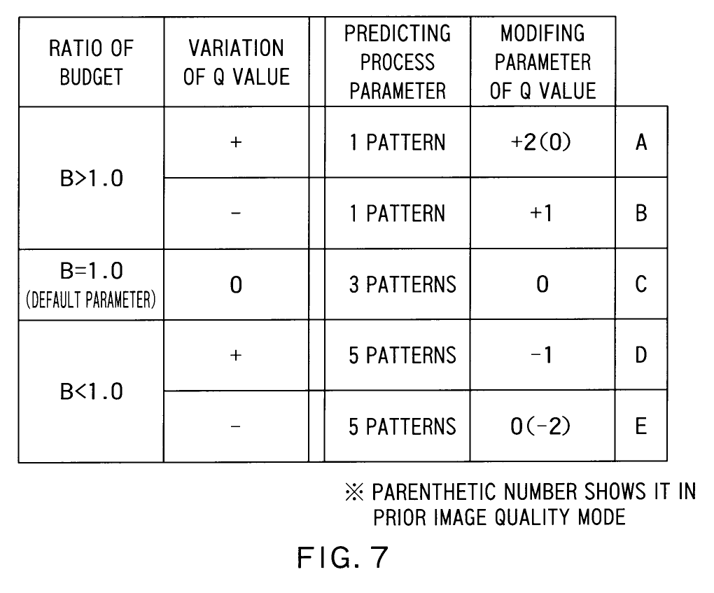

If the budget ratio of the measurement result of step S402 of FIG. 4 to the budget calculated in step S401 of FIG. 4 is higher than 1.0 (S602—A), and the variation of the Q factor shows a positive value (S603—Yes), the parameter configuring unit 208 sets an image processing parameter so as to reduce the search patterns and increase the variation of the Q factor (for example, to reduce the number of the search patterns from three to one, and to increase the variation of the Q factor by 2), using the parameter configuration table 1064 shown in A of FIG. 7 (S604). The parameter setting process in accordance with the second embodiment of the present invention then comes to an end.

If the budget ratio of the measurement result of step S402 of FIG. 4 to the budget calculated in step S401 of FIG. 4 is higher than 1.0 (S602—A), and the variation of the Q factor shows a negative value (S603—No), the parameter configuring unit 208 sets an image processing parameter so as to reduce the search patterns and increase the variation of the Q factor (for example, to reduce the number of the search patterns from three to one, and to increase the variation of the Q factor by 1), using the parameter configuration table 1064 shown in B of FIG. 7 (S605). The parameter setting process in accordance with the second embodiment of the present invention then comes to an end.

If the budget ratio of the measurement result of step S402 of FIG. 4 to the budget calculated in step S401 of FIG. 4 is lower than 1.0 (S602—B), and the variation of the Q factor shows a positive value (S606—Yes), the parameter configuring unit 208 sets an image processing parameter so as to increase the search patterns and reduce the variation of the Q factor (for example, to increase the number of the search patterns from three to five, and to reduce the variation of the Q factor by 1), using the parameter configuration table 1064 shown in D of FIG. 7 (S607). The parameter setting process in accordance with the second embodiment of the present invention then comes to an end.

If the budget ratio of the measurement result of step S402 of FIG. 4 to the budget calculated in step S401 of FIG. 4 is lower than 1.0 (S602—B), and the variation of the Q factor shows a negative value (S606—No), the parameter configuring unit 208 sets an image processing parameter so as to increase the search patterns (for example, to reduce the number of the search patterns from three to five), using the parameter configuration table 1064 shown in E of FIG. 7 (S608). The parameter setting process in accordance with the second embodiment of the present invention then comes to an end.

If the budget ratio of the measurement result of step S402 of FIG. 4 to the budget calculated in step S401 of FIG. 4 is 1.0 (S602—C), the parameter setting process in accordance with the second embodiment of the present invention comes to an end. In this case, the image processing unit 202 performs image processing, using the default parameters (for example, using three search patterns and the variation of the Q factor calculated by the rate controller 214).

In step S602, the parameter configuring unit 208 uses the budget ratio of the measurement result of step S402 to the budget of all the frames.

FIG. 7 schematically shows the parameter configuration table 1064 in accordance with the second embodiment of the present invention. In the case where the budget ratio measured by the throughput measuring unit 206 is 1.0 (B=1.0), the predicting process parameter is the default parameter to be used in image processing for the first macro block (see C of FIG. 7).

The parameter configuring unit 208 refers to the parameter configuration table 1064 shown in FIG. 7, when setting an image processing parameter. Accordingly, the parameter configuring unit 208 refers to A of FIG. 7 when carrying out the procedure of step S604 of FIG. 6, refers to B of FIG. 7 when carrying out the procedure of step S605, refers to D of FIG. 7 when carrying out the procedure of step S607, and refers to E of FIG. 7 when carrying out the procedure of step S608.

The parameter configuring unit 208 refers to the predicting process parameter, and sets predicting patterns for the predicting unit 2021. The throughput of the predicting unit 2021 becomes larger as the number of predicting patterns is larger with respect to the default parameter (three patterns), but becomes smaller as the number of predicting patterns is smaller.

The parameter configuring unit 208 calculates the variation of the Q factor and the modifying parameter of the Q factor, and sets the calculation result as the quantizing parameter (the variation of Q factor+the modifying parameter of Q factor) to the quantizing unit 2023. The amount of codes in the encoded data (a bit stream) generated by the encoder 204 becomes smaller as the calculation result is larger, but becomes larger as the calculation result is smaller.

Alternatively, the parameter configuring unit 208 of the second embodiment of the present invention may determine the modifying parameter of the Q factor, in accordance with the variation of the Q factor calculated by the rate controller 214. For example, in A of FIG. 7, the parameter configuring unit 208 may set the modifying parameter of the Q factor as “+2” when the variation of the Q factor is “+2”, and set the modifying parameter of the Q factor as “+3” when the variation of the Q factor is “+3”.

According to the second embodiment of the present invention, the parameter configuring unit 208 sets the image processing parameter in accordance with the variation of the Q factor as well as the magnitude relation between the throughput and the budget. Thus, it is possible to set a more proper image processing parameter than in the first embodiment of the present invention.

### Third Embodiment

Next, a third embodiment of the present invention is described. The first embodiment of the present invention concerns the basic parameter setting process. On the other hand, the third embodiment of the present invention concerns a parameter setting process to be carried out in cases where a power saving mode is set. Explanation of the same aspects as those of the first embodiment is omitted here. Incidentally, the third embodiment may be implemented in combination with the second embodiment of the present invention.

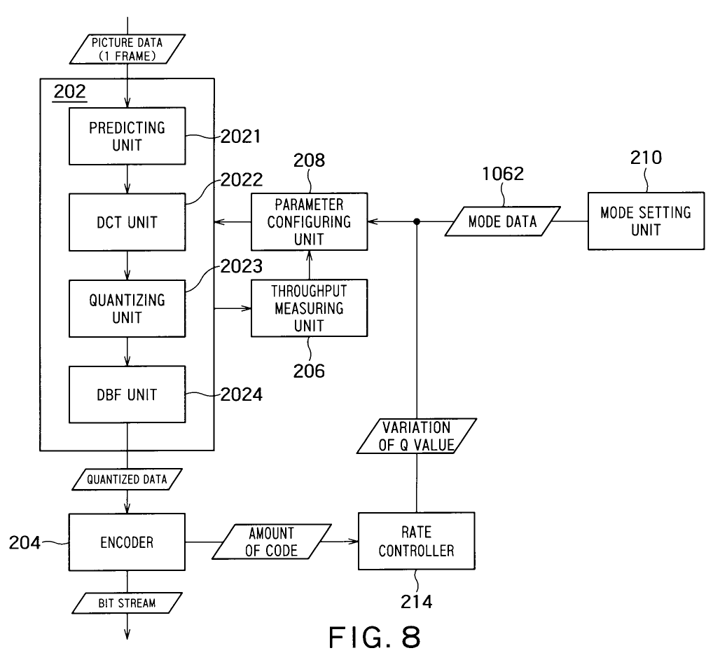

FIG. 8 is a block diagram showing the functions of the controller 104 of the third embodiment of the present invention. The functions shown in FIG. 8 are realized by the controller 104 activating the control program 1061 stored in the memory 106.

The controller 104 of the third embodiment of the present invention realizes a mode setting unit 210 as well as the same components as those of the first and second embodiments. The mode setting unit 210 sets the mode data 1062 stored in the memory 106 to the parameter configuring unit 208.

If the budget ratio of the measurement result of step S402 of FIG. 4 to the budget calculated in step S401 of FIG. 4 is lower than 1.0 (S602—B of FIG. 6), and the power saving mode is selected by the mode setting unit 210, the parameter configuring unit 208 of the third embodiment of the present invention ends a parameter setting process. In this case, the image processing unit 202 performs image processing, using the default parameters (for example, the number of search patterns being three, and the variation of the Q factor being the variation of the Q factor calculated by the rate controller 214).

Alternatively, the mode setting unit 210 of the third embodiment of the present invention may also be designed not only to set the power saving mode, but also to select an object (one of the image processing units 2021 through 2024 and the encoder 204) to be subjected to the parameter setting.

Alternatively, the mode setting unit 210 of the third embodiment of the present invention may also be designed not only to set the power saving mode, but also to set the parameter setting range (the upper and lower limits of the image processing parameter and the encoding parameters, or the threshold values). For example, the mode setting unit 210 may set the predicting process parameter at “7 patterns”, and set the modifying parameter of the Q factor at “−2” in D of FIG. 7.

Alternatively, the mode setting unit 210 of the third embodiment of the present invention may also be designed not only to set the power saving mode, but also to set an image quality mode or a code amount mode. For example, in a case where the mode setting unit 210 sets the image quality mode, the parameter configuring unit 208 does not carry out the procedure of step S604 of FIG. 6, but carries out the procedure of setting an image processing parameter so as to reduce the number of search patterns (for example, to reduce the number of search patterns from three to one), using the parameter configuration table 1064 shown with brackets in A of FIG. 7, and does not carry out the procedure of step S608 of FIG. 6, but carries out the procedure of setting an image processing parameter so as to increase the number of search patterns and to reduce the variation of the Q factor (for example, to increase the number of search patterns from three to five, and to reduce the variation of the Q factor by “2”), using the parameter configuration table 1064 shown with brackets in E of FIG. 7. In a case where the mode setting unit 210 sets the code amount mode, the parameter setting process of this embodiment is the same as the parameter setting process of the second embodiment of the present invention.

According to the third embodiment of the present invention, when the power saving mode is set in the third embodiment of the present invention, the image processing unit 202 performs image processing, using the default parameters, even if the budget ratio is lower than 1.0. Thus, it is possible to achieve the effect of saving the power consumption, as well as the same effects as those of the first embodiment of the present invention. In this case, the parameter setting process is ended, without a modification to the variation of the Q factor. Thus, the quantizing unit 2023 can perform quantization, with the control result (the variation of the Q factor) of the rate controller 214 being reflected in the quantization.

Also, according to the third embodiment of the present invention, the parameter configuring unit 208 configures parameters in accordance with the object and range to be subjected to the parameter setting, or based on whether it is in the image quality mode or the code amount mode. Thus, it is possible to configure various parameters in response to the requests of operators.

### Fourth Embodiment

Next, a fourth embodiment of the present invention is described. The first embodiment of the present invention concerns the basic parameter setting process. On the other hand, the fourth embodiment of the present invention concerns a parameter setting process to be carried out by referring to the history data about parameter settings. Explanation of the same aspects as those of the first to third embodiments is omitted here. The fourth embodiment may be implemented in combination with the second or third embodiment of the present invention.

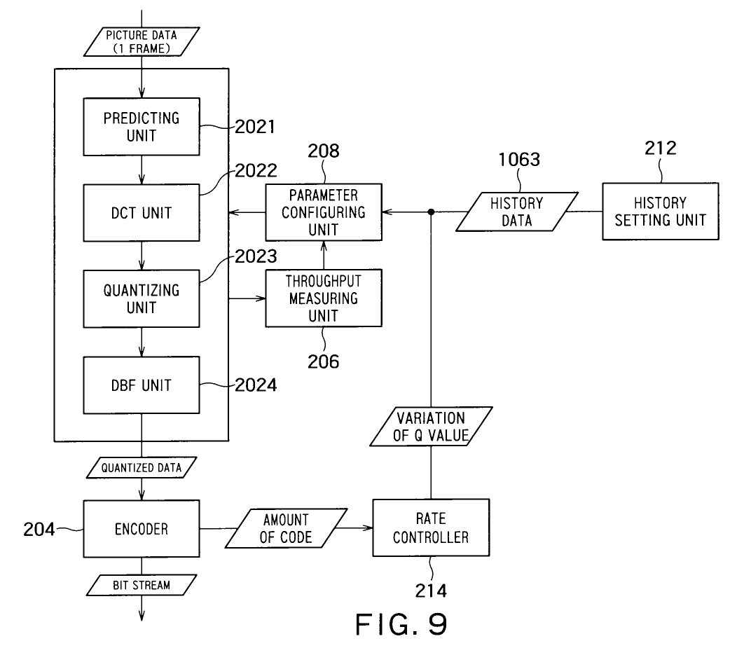

FIG. 9 is a block diagram showing the functions of the controller 104 of the fourth embodiment of the present invention. The functions shown in FIG. 9 are realized by the controller 104 activating the control program 1061 stored in the memory 106.

The controller 104 of the fourth embodiment of the present invention realizes a history setting unit 212 as well as the same components as those of the first embodiment of the present invention. The history setting unit 212 sets the history data 1063 stored in the memory 106 to the parameter configuring unit 208.

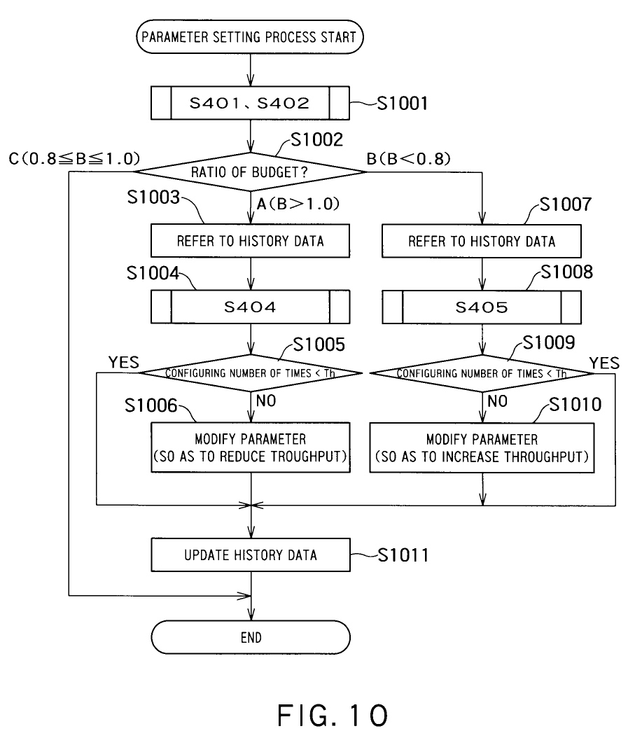

FIG. 10 is a flowchart showing the operation procedures to be carried out in a parameter setting process in accordance with the fourth embodiment of the present invention. This parameter setting process is carried out for each macro block in image data (picture data).

First, the same procedures as those of steps S401 and S402 of FIG. 4 are carried out (S1001).

If the budget ratio of the measurement result of step S402 of FIG. 4 to the budget calculated in step S401 of FIG. 4 is higher than 1.0 (S1002—A), the parameter configuring unit 208 refers to the history data 1063 stored in the memory 106 (S1003).

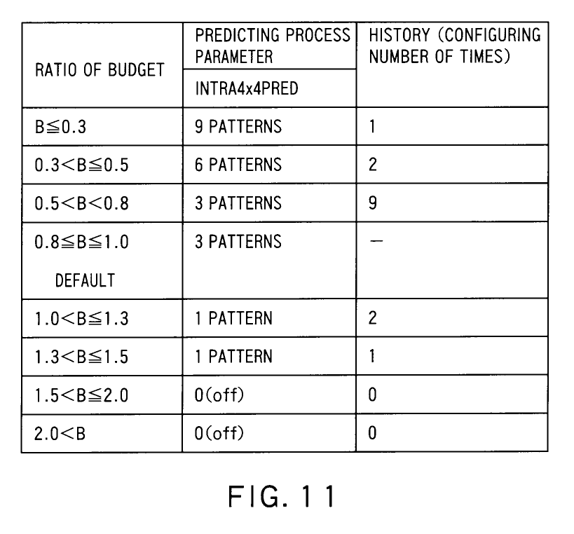

The parameter configuring unit 208 then carries out the same procedure as the procedure of step S404 of FIG. 4 (S1004). If the number of image processing parameter settings that is designated in step S1004 is equal to or greater than a threshold value that is set by the history setting unit 212 (S1005—No), the parameter configuring unit 208 resets the image processing parameter so as to reduce the throughput necessary for the controller 104 to perform image processing from the image processing parameter set in step S1004, using the parameter configuration table 1064 shown in FIG. 11 (S1006).

If the budget ratio of the measurement result of step S402 of FIG. 4 to the budget calculated in step S401 of FIG. 4 is lower than 0.8 (S1002—B), the parameter configuring unit 208 refers to the history data 1063 stored in the memory 106 (S1007).

The parameter configuring unit 208 then carries out the same procedure as the procedure of step S405 of FIG. 4 (S1008). If the number of image processing parameter settings designated in step S1008 is equal to or greater than a threshold value that is set by the history setting unit 212 (S1009—No), the parameter configuring unit 208 resets the image processing parameter so as to increase the throughput necessary for the controller 104 to perform image processing from the image processing parameter set in step S1008, using the parameter configuration table 1064 shown in FIG. 11 (S1010).

If the number of image processing parameter settings designated in step S1004 or S1008 is smaller than the threshold value that is set by the history setting unit 212 (S1005—Yes or S1009—Yes), or when the procedure of step S1006 or S1010 comes to an end, the history setting unit 212 increments the history data 1063, and updates the history data 1063 stored in the memory 106 (S1011). The parameter setting process in accordance with the fourth embodiment of the present invention comes to an end.

If the budget ratio of the measurement result of step S402 of FIG. 4 to the budget calculated in step S401 of FIG. 4 is in the range of 0.8 to 1.0 (S1002—C), the history setting unit 212 ends the parameter setting process of the fourth embodiment of the present invention. In this case, the history setting unit 212 does not perform the updating procedure of step S1011, and ends the parameter setting process of the fourth embodiment of the present invention.

To sum up, when the history data 1063 is equal to or greater than the threshold value, the parameter configuring unit 208 configures parameters so as to change the throughput of the controller 104 by a greater amount and to make the throughput of the controller 104 as close as possible to the budget.

In step S1002, the parameter configuring unit 208 uses the budget ratio of the measurement result of step S402 to the budget of all the frames.

FIG. 11 schematically shows the parameter configuration table 1064 of the fourth embodiment of the present invention. The predicting process parameter to be used in the case where the budget ratio measured by the throughput measuring unit 206 is in the range of 0.8 to 1.0 (0.8≦B≦1.0) is the default parameter to be used in the predicting process for the first macro block.

As shown in FIG. 11, the parameter configuration table 1064 of the fourth embodiment of the present invention comprises the history (the configuring number of times) of the parameter setting process of FIG. 10 associated with each budget ratio, as well as the same as the parameter configuration table 1064 of the first embodiment of the present invention.

For example, in a case where a threshold value of 10 is set by the history setting unit 212, and the budget ratio of the measurement result of step S402 of FIG. 4 to the budget calculated in step S401 of FIG. 4 is 0.7 (S1002—B), the number of times image processing parameter setting is performed (the predicting process parameter being three patterns) reaches 10 in step S1008. In this case, the configuring number of times is determined to be equal to or greater than the threshold value in step S1009 (S1009—No). Accordingly, the image processing parameter is reset to the image processing parameter (the predicting process parameter being six patterns) having a greater throughput next to the image processing parameter set in step S1008 (S1010).

According to the fourth embodiment of the present invention, the parameter configuring unit 208 resets parameters based on the history showing the number of times a parameter is configured, when there is a possibility that a frame might be missing even with the use of the image processing parameter obtained after a parameter setting process is carried out. Thus, it is possible to perform more proper parameter setting processes than in the first to third embodiments of the present invention.

What is claimed is:

1. An encoding device comprising:
an image processing unit that performs image processing on image data, using an image processing parameter;
a throughput measuring unit that measures throughput necessary in the image processing performed by the image processing unit;
a parameter configuring unit that configures the image processing parameter to the image processing unit, based on a magnitude relation between the throughput measured by the throughput measuring unit and a budget; and
an encoder that encodes the image data processed by the image processing unit, and generates encoded data.

2. The encoding device according to claim 1, further comprising:
a rate controller that calculates a variation of a quantization value, based on the amount of codes in the encoded data generated by the encoder,
wherein the parameter configuring unit configures the image processing parameter to the image processing unit, based on the variation of the quantization value calculated by the rate controller.

3. The encoding device according to claim 1, wherein:
the image processing unit includes a first image processing unit that performs first image processing, and a second image processing unit that performs second image processing based on a process result of the first image processing unit;
the throughput measuring unit measures throughput necessary in the first image processing performed by the first image processing unit, and throughput necessary in the second image processing performed by the second image processing unit; and
the parameter configuring unit configures at least one of image processing parameters of the first image processing unit and the second image processing unit to the image processing unit.

4. The encoding device according to claim 1, further comprising:
a mode setting unit that sets a power saving mode to the parameter configuring unit,
wherein the parameter configuring unit configures the image processing parameter to the image processing unit, when the power saving mode is not set by the mode setting unit.

5. The encoding device according to claim 1, further comprising:
a memory that stores history data about parameters that are configured by the parameter configuring unit; and
a history setting unit that sets the history data stored in the memory to the parameter configuring unit,
wherein the parameter configuring unit configures the image processing parameter to the image processing unit, referring to the history data set by the history setting unit.

6. The encoding device according to claim 2, wherein:
the image processing unit includes a first image processing unit that performs first image processing, and a second image processing unit that performs second image processing based on a process result of the first image processing unit;
the throughput measuring unit measures throughput necessary in the first image processing performed by the first image processing unit, and throughput necessary in the second image processing performed by the second image processing unit; and
the parameter configuring unit configures at least one of image processing parameters of the first image processing unit and the second image processing unit to the image processing unit.

7. The encoding device according to claim 2, further comprising
a mode setting unit that sets a power saving mode to the parameter configuring unit,
wherein the parameter configuring unit configures the image processing parameter to the image processing unit, when the power saving mode is not set by the mode setting unit.

8. The encoding device according to claim 2, further comprising:
a memory that stores history data about parameters that are configured by the parameter configuring unit; and
a history setting unit that sets the history data stored in the memory to the parameter configuring unit,
wherein the parameter configuring unit configures the image processing parameter to the image processing unit, referring to the history data set by the history setting unit.

9. The encoding device according to claim 3, further comprising
a mode setting unit that sets a power saving mode to the parameter configuring unit,
wherein the parameter configuring unit configures the image processing parameter to the image processing unit, when the power saving mode is not set by the mode setting unit.

10. The encoding device according to claim 3, further comprising:
a memory that stores history data about parameters that are configured by the parameter configuring unit; and
a history setting unit that sets the history data stored in the memory to the parameter configuring unit,
wherein the parameter configuring unit configures the image processing parameter to the image processing unit, referring to the history data set by the history setting unit.

11. The encoding device according to claim 4, further comprising:
a memory that stores history data about parameters that are configured by the parameter configuring unit; and
a history setting unit that sets the history data stored in the memory to the parameter configuring unit,
wherein the parameter configuring unit configures the image processing parameter to the image processing unit, referring to the history data set by the history setting unit.

12. The encoding device according to claim 6, further comprising:
a mode setting unit that sets a power saving mode to the parameter configuring unit,
wherein the parameter configuring unit configures the image processing parameter to the image processing unit, when the power saving mode is not set by the mode setting unit.

13. The encoding device according to claim 6, further comprising:
a memory that stores history data about parameters that are configured by the parameter configuring unit; and
a history setting unit that sets the history data stored in the memory to the parameter configuring unit,
wherein the parameter configuring unit configures the image processing parameter to the image processing unit, referring to the history data set by the history setting unit.

14. The encoding device according to claim 7, further comprising:
a memory that stores history data about parameters that are configured by the parameter configuring unit; and
a history setting unit that sets the history data stored in the memory to the parameter configuring unit,
wherein the parameter configuring unit configures the image processing parameter to the image processing unit, referring to the history data set by the history setting unit.

15. The encoding device according to claim 12, further comprising:
a memory that stores history data about parameters that are configured by the parameter configuring unit; and
a history setting unit that sets the history data stored in the memory to the parameter configuring unit,
wherein the parameter configuring unit configures the image processing parameter to the image processing unit, referring to the history data set by the history setting unit.
